(19) United States
(12) Patent Application Publication
(10) Pub. No.: US 2015/0226563 A1
(43) Pub. Date: Aug. 13, 2015

(54) SYSTEM AND METHOD FOR DETERMINING ROUTE INFORMATION FOR A VEHICLE USING ON-BOARD DIAGNOSTIC DATA

(71) Applicant: Metromile, Inc., San Francisco, CA (US)

(72) Inventors: Evan Gabriel Turitz Cox, Pleasant Hill, CA (US); Daniel Eric Goodman, Mountain View, CA (US); Dan Richard Preston, San Francisco, CA (US); Stephen Thomas Pretre, Woodside, CA (US); Muhammad Waliji, San Francisco, CA (US)

(73) Assignee: Metromile, Inc., San Francisco, CA (US)

(21) Appl. No.: 14/177,188

(22) Filed: Feb. 10, 2014

(51) Int. Cl. G01C 21/34; G07C 5/00

(52) U.S. Cl. CPC G01C 21/34; G07C 5/00

(57) ABSTRACT

A system and method is provided for analyzing route information for a vehicle. In particular, a determination is made as to whether a vehicle is on a trip. The determination can include identifying a starting point and a destination. On-board diagnostic data is obtained from the vehicle during the trip. A vehicle metric is determined for the vehicle based at least in part on the on-board diagnostic data. A route is determined between the starting point and the destination that is optimized for the vehicle metric

### TECHNICAL FIELD

Examples described herein relate to a system and method for determining route information for a vehicle using onboard diagnostic data.

### BACKGROUND

Vehicles increasingly rely on computers and sensors for variety of purposes. With time, the information determined from a vehicle is increasingly more sophisticated, and more comprehensive about a variety of aspects relating to the operation of a vehicle.

### BRIEF DESCRIPTION OF THE DRAWINGS

FIG. 1 illustrates a system for using vehicle usage data to facilitate vehicle operations and services, according to embodiments.

FIG. 2A illustrates an example hardware implementation of vehicle interface device, according to one or more embodiments.

FIG. 2B illustrates a programmatic system for the vehicle monitor, according to an embodiment.

FIG. 3 illustrates a route analysis system, according to an embodiment.

FIG. 4 illustrates a usage profiling system, according to an embodiment.

FIG. 5 illustrates an example method for optimizing a route of a vehicle based on a vehicle metric such as fuel consumption, according to an embodiment.

FIG. 6 illustrates an example method for estimating fuel stops for a monitored vehicle, according to an embodiment.

FIG. 7 illustrates an example method for fingerprinting a driver utilizing a monitored vehicle for purpose of providing services that account for individual drivers, according to an embodiment.

FIG. 8 illustrates a method for estimating future repair or service events based on vehicle information of a monitored vehicle, according to an embodiment.

### DETAILED DESCRIPTION

Examples described herein provide for a vehicle monitor device that obtains various kinds of information in the context of a vehicle that is being driven. The information determined from monitoring the vehicle is used for a variety of purposes, including optimizing route selection based on fuel efficiency, profiling drivers as well as the vehicle, and providing related services for the vehicle that include insurance or warranty and repair services. By way of example, the information determined from monitoring the vehicle can include onboard diagnostic data, motion data, and position information.

In more detail, some embodiments include a system and method for analyzing route information of a vehicle. In particular, a determination is made as to whether a vehicle is on a trip. The determination can include identifying a starting point and a destination. On-board diagnostic data is obtained from the vehicle during the trip. A vehicle metric is determined for the vehicle based at least in part on the on-board diagnostic data. A route is determined between the starting point and the destination that is optimized for the vehicle metric.

The vehicle metric refers to a quantitative or categorical assessment of a resource of a vehicle. According to some embodiments, the vehicle metric refers to fuel consumption, including fuel efficiency and overall fuel consumption. In variations, the vehicle metric can refer to parameters that reflect remaining resources (e.g., battery, replenish it will components) and component longevity. As a categorical assessment, the vehicle metric may indicate a state or condition of the vehicle, such as whether the battery is low.

According to additional embodiments, one or more destinations for a vehicle are predicted in a given time frame. On-board diagnostic data is determined from the vehicle, and a determination is made, based at least in part on the on-board diagnostic data, regarding suggested route information for the vehicle. The suggested route information is communicated to a device or account associated with the vehicle.

In some embodiments, the suggested route information entails identifying recommended fuel stops for the vehicle. The recommendations for fuel stops can be based a prediction of the fuel usage of the vehicle, which can include predicting the destinations of the vehicle over an upcoming time frame.

Still further, examples described herein include a system that includes a vehicle monitor device and one or more processors. The vehicle monitor device interfaces with a vehicle in order to obtain on-board diagnostic information from the vehicle. The vehicle interface can include a wireless transmitter to communicate the on-board diagnostic information to the computing destination. One or more processors associated with the computing destination use the on-board diagnostic information to calculate at least one of a vehicle metric or route information for the vehicle.

Still further, some embodiments provide for profiling vehicle usage. In particular, a vehicle usage data is obtained for a vehicle in use. The driver profile is determined at each of the multiple instances when the vehicle is in use. The driver profile can be based at least in part on the vehicle information. The driver of the vehicle at each of the multiple instances can be identified based at least in part on the usage profile. The driver can be identified from one of multiple possible driver who can use the vehicle.

In still another embodiment, the vehicle usage can be analyzed for purpose of predicting repair or maintenance requirements of a vehicle. On-board diagnostic data is obtained from a vehicle. The route information is recorded for a route taken by the vehicle. One or more future repair or maintenance requirements of the vehicle are determined based at least in part on the onboard diagnostic data and the route information.

Still further, according to some embodiments, driver behavior is programmatically analyzed in order to identify modifications that can improve a particular vehicle metric. In one implementation, vehicle data is obtained from the vehicle that is in motion. The vehicle data can include on-board diagnostic data. A particular behavior of the driver of the vehicle can be determined based on the onboard diagnostic data. A modification to the particular behavior can then be determined in order to improve or change a vehicle metric. Content can be output (e.g., application content, message, etc.) at that identifies the modification to the driver the vehicle.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

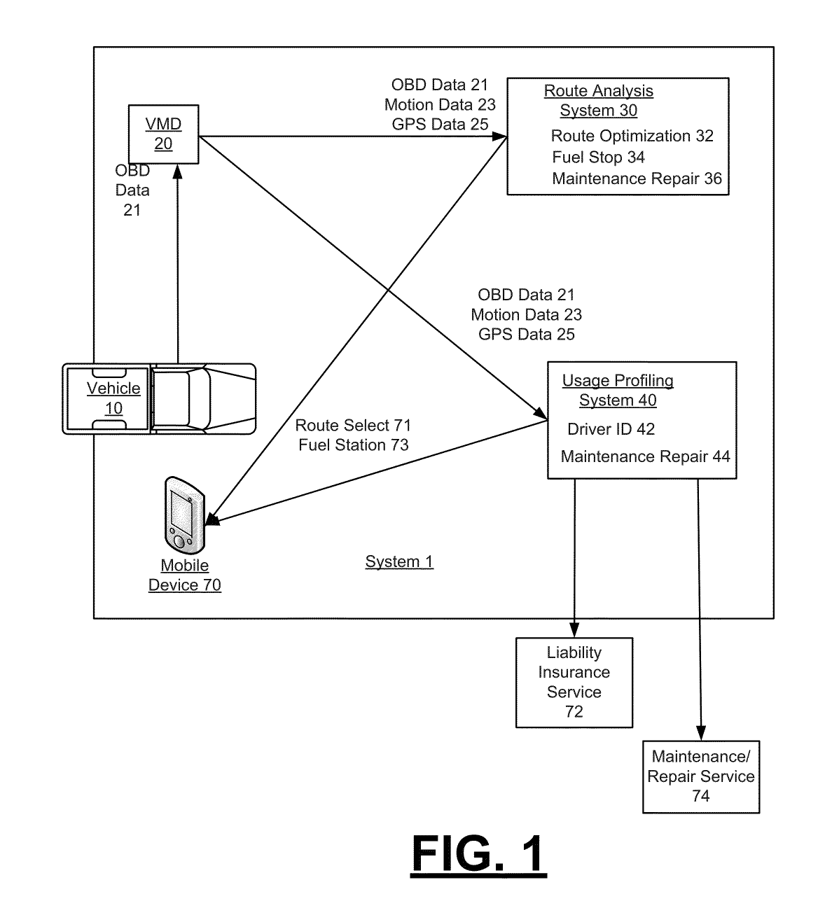

FIG. 1 illustrates a system for obtaining and using vehicle usage data in connection with providing various services relating to the use operation of the vehicle, according to one or more embodiments. In an example of FIG. 1, a system 1 includes a vehicle monitor device 20, and one or more network systems to analyze and use vehicle usage data as provided by the vehicle monitor device 20 (alternatively referred to as “network analysis systems”). In some implementations, system 1 includes a mobile device 70 to receive services from a network analysis system. This system 1 can operate in connection with the vehicle 10, to provide services as described with various embodiments described herein.

In some embodiments, a network analysis system includes a route analysis system 30 which obtains data from the vehicle monitor device 20 in order to perform operations for route analysis and optimization. Still further, in some embodiments, an analysis system includes a usage profiling system 40, which obtains data from the vehicle monitor device 20 for purpose of profiling one of a driver or the vehicle

The mobile device 70 can be used to interface with each of the one or more network services. By way of example, the mobile device 70 can correspond to a cellular messaging/telephony device operated or held by the user while driving the vehicle 10.

In more detail, the vehicle monitor device 20 operates within the vehicle 10 to obtain data values that are generated from the internal systems of the vehicle 10. For example, the vehicle 10 can be provided with an internal system that generates and outputs on-board diagnostic data 21 (“OBD data 21”), in connection with monitoring, controlling and regulating various automotive systems, components and sensors of the vehicle 10. According, the OBD data 21 can include a plurality of data items that are determined from an internal computing system of vehicle 10 when the vehicle is in use. Examples of OBD data 21 includes data generated through the OBD-II standard. By way of example, the OBD data 21 can include data parameters that represent fuel consumption, mass airflow, manifold air flow pressure, revolutions-per-minutes (“RPM”), intake air temperature, speed, tire pressure, brake usage data, and oil pressure. Numerous other data parameters are also available through, for example, vehicles that operate under the OBD-II standard.

In some embodiments, the vehicle monitor device 20 includes components that can obtain vehicle usage information independent of data generated through the internal system of the vehicle 10. In one implementation, the vehicle monitor device 20 includes one or more accelerometers, which can generate data representing motion data 23. The motion data 23 can identify, for example, vehicle acceleration (including braking and directional acceleration). In another implementation, the vehicle monitor device 20 includes a Global Positioning System component that provides location information (“GPS data 25”) regarding the position of the vehicle 10.

In an embodiment, the route analysis system 30 includes processes data provided from the vehicle monitor device 20 in performing a process for route optimization (“route optimization 32”). In particular, the route optimization 32 determines a route between a starting point and a destination point that is optimized for one or more vehicle metrics. The vehicle metric can referred to a quantifiable aspect for the operation of the car. Specific examples of vehicle metrics include, fuel consumption or efficiency (e.g., miles per gallon), consumption of other resources such as battery, water or air, and information relating to the longevity of specific components, such as batteries, tire, engine etc. By way of example, the route optimization 32 determines a route between a starting point and a destination point that is optimized for fuel efficiency or vehicle or component (e.g., tire, engine) longevity. In variations, the vehicle metric can refer to a categorical assessment regarding the condition or state of the vehicle. For example, the categorical assessment can indicate fuel level, battery level, a condition or state of the car at a particular time (e.g., parked).

As an addition or alternative, route analysis system 30 can include processes for optimizing fuel stops based on fuel efficiency and pricing of fuel stations (“fuel stop 34”). The fuel stop 34 can suggest times and places when the vehicle 10 should stop for fuel. Still further, the route analysis system 30 can include processes for selecting routes to optimize or otherwise reduce maintenance repair (“maintenance repair 36”).

Among other information, the route analysis system 30 can communicate a selected route 71 or fuel station 73 to the mobile device 70. Alternatively, the communication from the route analysis system 30 can be communicated to an integrated interface of the vehicle 10. Still further, the communication from the route analysis 30 can be directed to a device or location that is not associated directly with the vehicle 10. For example, the communication from route analysis 30 can be directed to a user account or device in a manner that is a asynchronous with the use of the vehicle. In one implementation, the mobile device 70 can include an application that is configured to communicate with the route analysis system 30. Alternatively, the mobile device 70 can be operated to access the route analysis system 30 using a browser in order to obtain the select route 71 or fuel station 73. Still further, the route analysis system 30 can communicate the selected route 71 or fuel station 73 via a messaging program.

In an embodiment, the usage profiling system 40 includes processes for determining or fingerprinting a driver of vehicle 10 (computer-implemented process labeled as “driver ID 42”). In particular, the driver ID 42 can utilize one or more of OBD data 21, motion data 23 and/or GPS data 25 in order to determine an identity or profile type of a driver of the vehicle 10. By way of example, the vehicle 10 can be associated with a household that includes three drivers: an adult male (father), an adult female (mother) and a teenager (child). The data from the vehicle monitor device 20 can be used to determine who was driving the vehicle 10 at each instance when the vehicle is in use.

The usage profiling system 40 can also include a process for predicting maintenance or repair events of the vehicle 10 (computer-implemented process labeled as “maintenance repair 44”). In particular, the maintenance repair 44 can utilize one or more of OBD data 21, motion data 23 and/or GPS data 25 in order to predict when maintenance or repair events may occur.

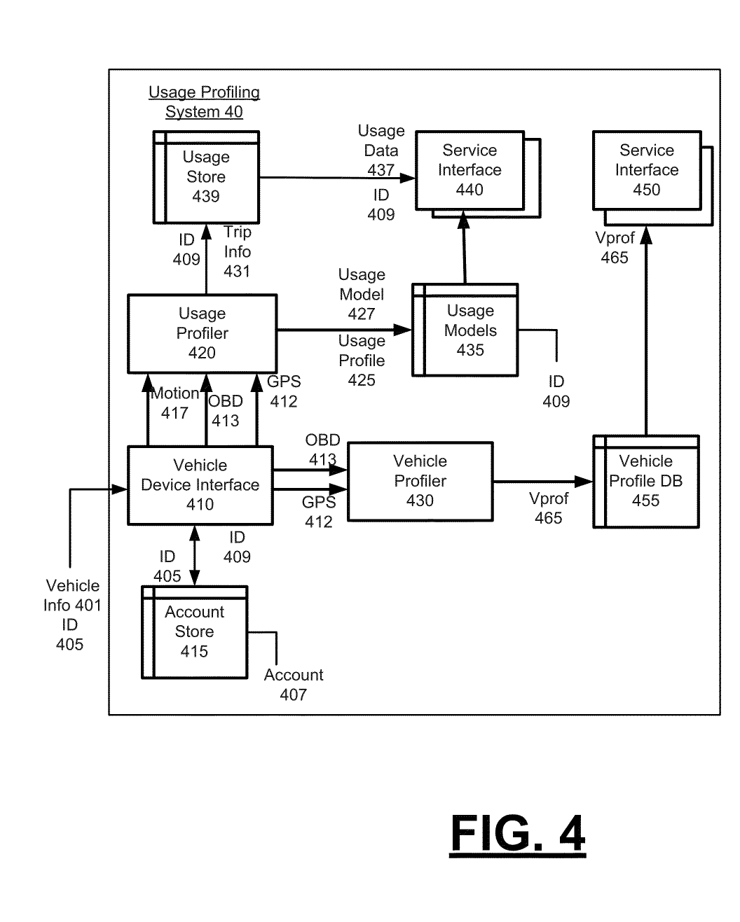

The network services described with an example of FIG. 1 can be combined or integrated with additional products and services that benefit a driver or owner of the vehicle. For example, in one embodiment, a liability insurance service 72 can communicate with (or be combined with) a usage profiling system 40. As described with an example of FIG. 4, liability insurance service 72 can utilize the usage profiling system 40 to fingerprint different drivers of the vehicle 10. Additionally, liability insurance service 72 can price insurance products and services based on driver fingerprinting (e.g., determine which driver is driving the vehicle 10), driver profiling and/or vehicle usage monitoring (e.g., distance driven by each driver). For example, liability insurance for vehicle 10 can be priced based on a distance driven by each driver of the vehicle, where each driver has a different risk profile.

Additionally, a maintenance repair service 74 can utilize output from usage profiling system 40 in order to provide repair and warranty services. By way of example, such services can predict vehicle failure (e.g., vehicle component breaks down) and service events (e.g., vehicle needs servicing due to normal wear and tear), as well as services to provide insurance for repairing the vehicle 10. Such products and services can utilize the vehicle profile as determined by, for example, maintenance repair process 44.

Still further, the mobile device 70 can communicate, or receive communications from the usage profiling system 40. In one implementation, the mobile device 70 receives messages that convey results or output of the usage profiling system 40. In variations, the mobile device 70 can execute an application that communicates with the usage profiling system 40 in order to receive the service's information or output. In some variations, the communications from the usage profiling system 40 can be communicated while the user is driving. Still further, the output of the usage profiling system can be communicated asynchronously to the user, and/or to third-parties or vendors (e.g., services that provide insurance services).

Vehicle Monitor

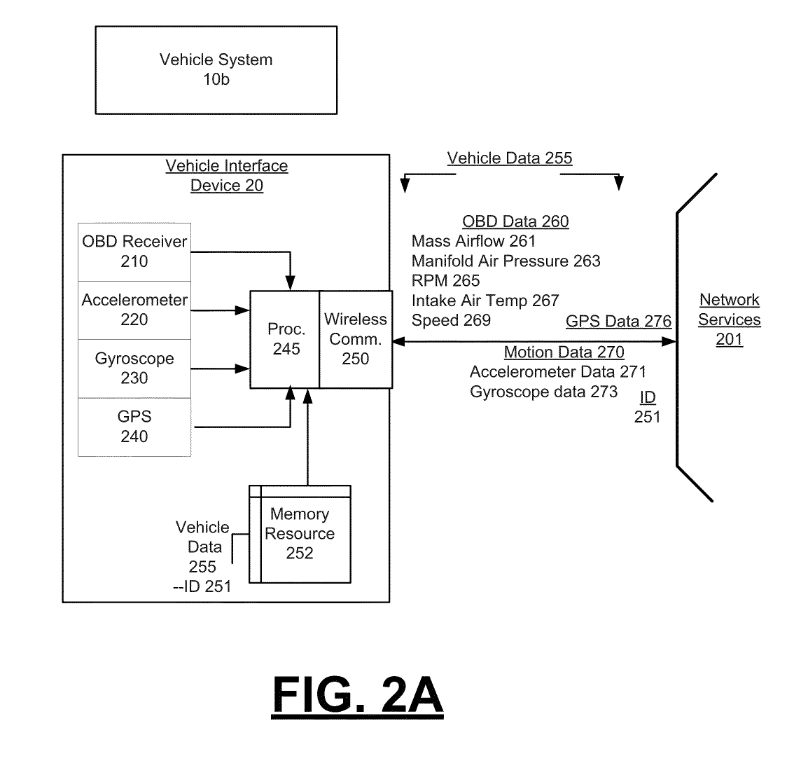

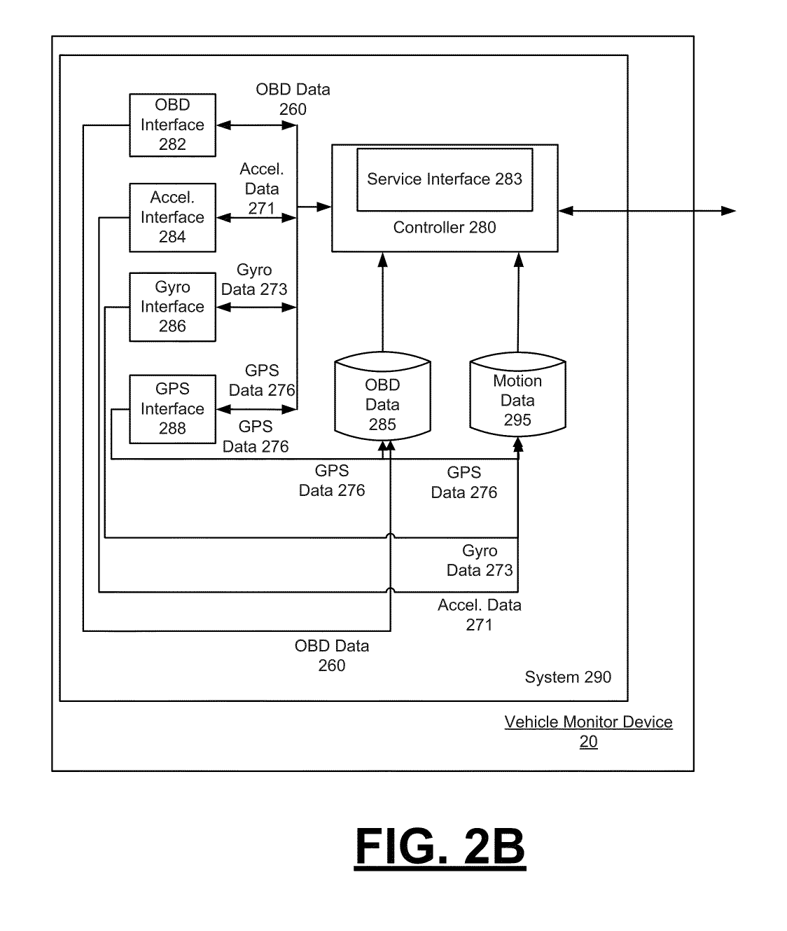

FIG. 2A illustrates an example hardware implementation of vehicle monitor device 20, according to one or more embodiments. In an example such as shown by FIG. 2A, vehicle monitor device 20 includes an on-board data interface (“OBD interface 210”), accelerometer 220, a gyroscope 230, a GPS component 240, a processing resource 245, a wireless communication device 250 and a memory resource 252. The wireless communication device 250 can enable wireless transmission and exchange of data between the vehicle monitor device 20 and one or more network services 201 (e.g., route analysis system 30 or usage profiling system 40 in FIG. 1). In one implementation, the network service 201 can include route analysis system 30 and/or usage profiling system 40. As described with an example of FIG. 2A, the processing resource 245 can control various components of the vehicle monitor device 20, including the OBD interface 210, the accelerometer 220, gyroscope 230, GPS component 240 and wireless communication device 250.

In one implementation, the wireless communication device 250 can transmit and receive data using a cellular communication medium. In variation, the wireless communication device 250 can transmit and receive data using a local communication medium, such as provided under a Wireless Fidelity (“Wi-Fi”) protocol (e.g., 802.11(a), (b), (g) or (n)) or Bluetooth. When implemented with the local communication medium, the vehicle monitor device 20 can alternatively communicate with network services 201 using an access point or an intermediary device (e.g., mobile device 70).

In communicating with the network service 201, wireless communication device 250 can signal an identifier 251. The network service 201 can associate the identifier 251 of the vehicle monitor device 20 with an account 203 and/or a particular vehicle. Additionally, the wireless communication device 250 can signal data obtained by the various components of the vehicle monitor device 20 (“device data 255”) to the network service 201. Once the identifier 251 is communicated, the vehicle monitor device 20 can signal the device data 255 in a discrete transmission or series of transmissions (e.g., as a log file when a trip is over). Alternatively, some or all of the vehicle data 255 can be signaled continuously or periodically (e.g., as the vehicle progresses in a trip). Still further, the wireless communication device 250 can push the vehicle data 255 to the network service 201. Alternatively, the network service 201 can request specific data sets from the vehicle monitor device 20.

In an embodiment, the vehicle data 255 and/or the identifier 251 can be stored in the memory resource. In one implementation, the vehicle data 255 can be correlated by time and/or vehicle position and then stored in the memory resource 252. The network service 201 can request specific data items from the vehicle monitor device 20, and the wireless communication device 250 can retrieve and signal the requested data from the memory resource 252 to the network service 201. Alternatively, the vehicle data 255 and the identifier 251 can be pushed, either selectively or at once time, to the network service 201. For example, vehicle data 255 can be stored in the memory resource 252 and then signaled to the network service 201 periodically at a particular time.

As described with an example of FIG. 1, the vehicle data 255 can be obtained from various components of the vehicle monitor device 20. The vehicle data 255 can be stored with the memory resource 252 and/or communicated from the wireless communication device 250 to the network service 201. In some embodiments, the vehicle data 255 includes OBD data 260 obtained from the OBD interface 210. In particular, the OBD interface 210 can interface with a data port of vehicle system 10b in order to receive OBD data 260 from the vehicle 10. For example, the vehicle 10 can generate on-board diagnostic data such as defined under the OBD-II standard. By way of example, the OBD data 260 can include mass airflow measurement 261, manifold air pressure measurement 263, RPM 265 (taken at various instances when the vehicle is in use), intake air temperature 267 and speed 269. Various other kinds of data items can be obtained from the OBD interface 210, including real-time fuel consumption.

Still further, the vehicle data 255 can include motion data 270, which can be obtained from one or more accelerometers 220 and/or gyroscope 230. Accordingly, the motion data 270 can include acceleration data 271 obtained from one or more of the accelerometers 220. Alternatively, the motion data 270 can include gyroscope data 273 obtained from the gyroscope 230. The acceleration data 271 can include data that (i) identifies the acceleration of the vehicle to a given speed, (ii) data that identifies de-acceleration events (e.g., braking), including an amount of de-acceleration, and (iii) data that identifies the vehicle turning or otherwise undergoing lateral movement or acceleration.

Additionally, the vehicle data 255 can include GPS data 276 which identifies the location of the vehicle 10. In one implementation, the GPS data 276 can be communicated to the network service 201 continuously in order to identify the position of the vehicle in real-time. In a variation, the GPS data 276 can be linked with other vehicle data 255, such as OBD data 260, so that other kinds of vehicle data 255 (e.g., OBD data 260) are correlated to a position of the vehicle.

FIG. 2B illustrates a programmatic system for the vehicle monitor device 20, according to an embodiment. In one aspect, a programmatic system 290 can be implemented using the processing resource 245 of the vehicle monitor device 20 (see FIG. 2B). Accordingly, programmatic system 290 is described in context of a hardware implementation such as shown with an example of FIG. 2A.

In an example of FIG. 2B, programmatic system 290 includes a controller 280 having a service interface 283, an OBD interface 282, an accelerometer interface 284, a gyroscope interface 286 and a GPS interface 288. The controller 280 can control various devices and interfaces of the vehicle monitor device 20, and further perform operations to collect or aggregate information for communication to an external source such as a particular network service. The service interface 283 can link the vehicle monitor device 20 to one or more network services, such as a route analysis system 30 (see FIG. 1) or usage profiling system 40 (see FIG. 1). For example, the service interface 283 can signal data (e.g., vehicle data) along with the identifier 251 to network service 201, and also receive device or account-specific data from the network service 201.

The OBD interface 282 enables the controller 280 to access and control the OBD interface 210 (FIG. 2A) in receiving OBD data from the vehicle 10. The controller 280 can use the accelerometer interface 284 to interface and control each of one or more accelerometers 220 (FIG. 2A) of the vehicle monitor device 20. Likewise, the controller 280 uses the gyroscope interface 286 to control and interface with the gyroscope 230 (FIG. 2A). Additionally, the controller 280 uses the GPS interface 288 to interface and control the GPS component 240 (FIG. 2A).

In one aspect, the controller 280 uses collection rules 281 in order to communicate data from any of the components of the vehicle monitor device 20 to the network service 201. For example, the collection rules 281 can specify real-time access of select data from one or more of the components of the vehicle monitor device 20. As an addition or alternative, the collection and communication of data from some or all of the components of the vehicle monitor device 20 can be based on designated events or triggers. For example, accelerometer data 271 can be collected and communicated in real-time to the network service 201 in response to detection of an event determined from GPS data 276 (e.g., vehicle is no longer in a designated proximity to home). In still another aspect, the controller 280 can receive instructions from the network service 201 (e.g., route optimization service) in order to determine what data items are to be collected and communicated to the network service.

As an addition or alternative, the components of the vehicle monitor device 20 can collect and store data on the vehicle monitor device 20 for subsequent use. In one implementation, the controller 280 uses the OBD interface 282 to collect and store OBD data 260 in the OBD data store 285. Additionally, the controller 280 can use the accelerometer interface 274 and/or the gyroscope interface 286 to collect and store accelerometer data 271 and/or gyroscope data 273 in the vehicle motion database 295. In some implementation, GPS data 276 can be correlated to the OBD data 260, accelerometer data 271, and gyroscope data 273. For example, acceleration data 271 can include parameters that identify vehicle acceleration at specific instances, and this data can be correlated to GPS data 276 in the motion data store in order to identify the location where such data was obtained on the vehicle monitor device 20. Likewise, the OBD data 260 can include parameters (e.g., RPM value, speed, air manifold temperature) that are determined at specific instances of the trip, and these parameters can be correlated to GPS data 276 in the OBD data store 285 in order to identify the location where such data was obtained.

According to one aspect, the service interface 283 can receive requests for stored data with the OBD data store 285 and/or motion data store 295. In this way, the system 290 can be implemented to record historical information about a vehicle, and the information recorded on the vehicle monitor device 20 can be transmitted to a network service at, for example, discrete intervals.

In still another aspect, the service interface 283 can implement rules for communicating data from the OBD data store 285 and/or motion data store 295 to the network service 201. The collection rules 281 can specify when, for example, OBD data 260 that is to be collected, which OBD parameters are to be collected, and events or conditions when the OBD data 260 are to be transmitted to a particular network service. Similar rules can be implemented in order to control how motion data is obtained and/or communicated to a particular network service. As an addition or alternative, the service interface 283 can receive instructions for retrieving data from one of the OBD data store 285 and/or motion data store 295.

Numerous examples are provided herein regarding the use of vehicle data. By way of example, vehicle data can be obtained and used to determine when the vehicle is being towed, burglarized or in a collision or accident. With reference to FIG. 2A and FIG. 2B, for example, motion data 270 (e.g., accelerometer data 271) can detect instances when the vehicle is being moved, and/or moved at an incline. Additionally, the vehicle data 255 can communicate whether the vehicle is on or off. For example, voltage sensor data can indicate the ignition status of the vehicle. Additionally, GPS data 276 and/or historical information can indicate a location of the vehicle. The combination of data present with vehicle data 255 can readily be used to determine whether the vehicle is on or off, but moving. The combination of the vehicle state (on or off), followed by indication that the vehicle is moving can serve as an indication that the vehicle is being towed or stolen. If the vehicle is further indicated at being partially inclined (as can be determined by accelerometer data 271 and/or gyroscope data 273), the information can be indicative that the vehicle is being towed.

Route Analysis System

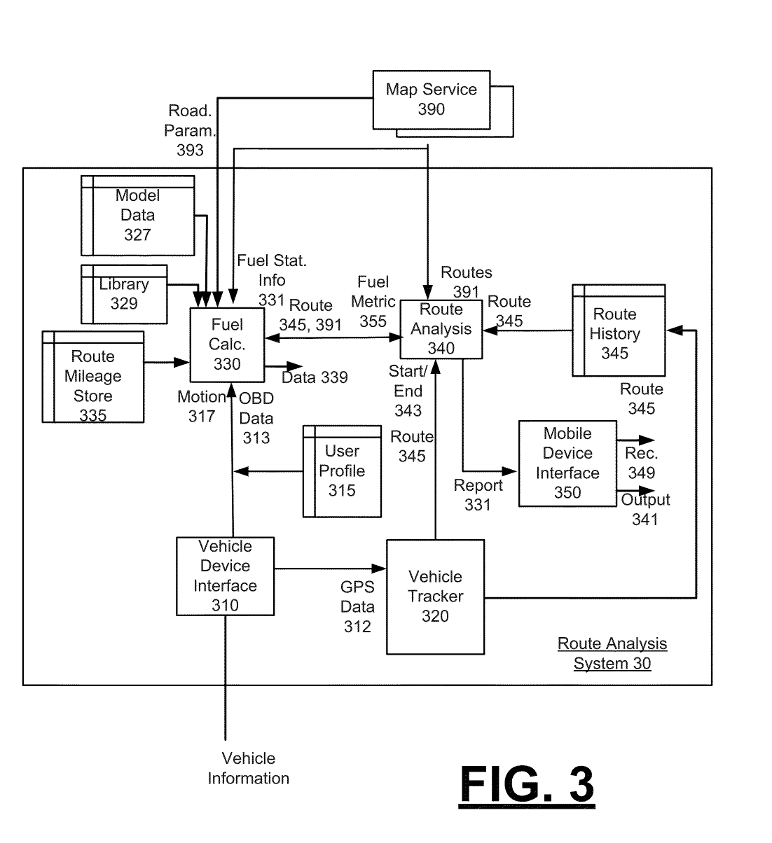

FIG. 3 illustrates a route analysis system, according to an embodiment. A route analysis system 30, such as shown by an example of FIG. 3, is an example of a network service that can interface with the vehicle monitor device 20 in order to provide functionality for use with operation of the vehicle (see FIG. 1). Among other functions, the route analysis system 30 can operate to suggest optimal routes for a vehicle, given a vehicle metric such as fuel consumption. As an alternative or variation, route analysis system 30 can operate to provide feedback as to how the driver could have driven a route in a manner that is more optimal, given an actual route of the driver.

In more detail, route analysis system 30 includes a vehicle device interface 310, a vehicle tracker 320, a fuel calculation component 330, route determination 340, and a mobile device interface 350. The vehicle device interface 310 can link with one or multiple vehicle monitor devices 20 (See FIG. 1, FIG. 2A and FIG. 2B) in order to receive vehicle information 301 from a corresponding vehicle. As described with a prior example, the vehicle information 301 can include one or more of (i) GPS information 312, (ii) OBD data 313, and/or (iii) motion data 317.

The route analysis system 30 can also maintain a user profile store 315 which maintains information about a user from an alternative source (to vehicle monitor device 20). In one aspect, the user profile store 315 includes information provided by the user. This information can, for example, identify a make or type of the vehicle, as well as demographic information of the user. As an alternative or addition, the information maintained by the profile store 315 can include preferences of the user. For example, the driving style (how much braking does user perform, average speed, etc.) of the user can be provided from the user, rather than observed and implemented accordingly.

The vehicle device interface 310 can communicate the GPS data 312 to the vehicle tracker 320. In turn, the vehicle tracker 320 can track the position of the vehicle in context of, for example, maps or coordinates for a map. The vehicle tracker 320 can communicate data to a route analysis component 340 for purpose of determining a route being undertaken by the vehicle during a given trip. In one implementation, data communicated from the vehicle tracker 320 can also identify a start and end point 343 for a given trip.

In an embodiment, the route analysis system 30 provides real-time determinations for purpose of optimizing fuel consumption. The vehicle tracker 320 can include logic to detect when the vehicle is embarked on a trip that meets a criteria of distance or duration. The vehicle tracker 320 detects an initial portion of a route (e.g., the vehicle leaves a home and starts on a roadway) and monitors the GPS information 312 to confirm that the user is likely on a trip of sufficient duration for analysis to be performed. The vehicle tracker 320 can also use a calendar or historical log to confirm, for example, that the vehicle is likely on route to a given destination (e.g., driver is going to work in the morning).

Accordingly, the vehicle tracker 320 can output data that corresponds to an actual route 345 taken by the driver. Additionally, the vehicle tracker 320 can output data that identifies the start and end points 343 for the route taken (or being taken). In some variations, data communicated to the vehicle tracker 320 can identify a route 345 that is likely being taken by the vehicle in real-time, meaning identification of the route 345 occurs before the route is completed.

Alternatively, the vehicle tracker 320 can store routes 345 taken by the vehicle in a route history store 347 for subsequent use and analysis. In such an implementation, the route analysis system 30 analyzes routes after they have been completed. For example, the route analysis component 340 can make determinations based on historical logs (as provided by the route history store 347) to determine start and end points 343 and/or routes 345 actually taken by the vehicle.

The route analysis component 340 operates to compare the actual route 345 taken by the vehicle with a set of one or more alternative routes 391. The alternative routes 391 can be determined from a map service 390 (e.g., third-party map service). In alternative variations, the alternative routes 291 can be determined from monitoring other users who travel between the same general start and end points. The actual route 345 can be determined in near real-time based on input from the vehicle tracker 320. Alternatively, the route analysis component 340 can utilize previously recorded routes, as provided by route history store 347. In either case, the comparison can be to determine whether the actual route taken by the vehicle, either in a current instance or in a past instance, is optimal based on a vehicle metric such as fuel efficiency.

In an embodiment, the route analysis component 340 can provide the actual route taken 345 and one or more multiple possible routes 391 as input for fuel calculation component 330. The routes provided as input to the fuel calculation component 330 can include the actual route taken 345 (as determined between the start and end points 343), as well as the hypothetical routes 391 that the vehicle could have taken between the determined start and end points 343.

In an embodiment, the fuel calculation component 330 can (i) make a determination that correlates to fuel consumption of the vehicle for an actual route taken, and (ii) make a determination that correlates to fuel consumption of the vehicle for hypothetical routes (e.g., routes that the vehicle did not take but could have). In estimating the fuel consumption of the vehicle for the actual route taken, the fuel calculation component 330 can utilize different types of vehicle information. In one implementation, fuel calculation component 330 uses OBD data 313, as determined from the vehicle between the start and end points 343. The OBD data 313 relevant for determining fuel efficiency can include, for example, fuel consumption readings, which can, in some instances, be obtained in real-time and then mapped to fuel efficiency (e.g., miles-per-gallon). Thus, in some variations, the OBD data 313 can include data to reflect actual measurements of fuel levels of the vehicle. As an alternative or addition, the fuel consumption readings can be determined from mass air flow, manifold air pressure, RPM an intake air temperature. Additionally, in some variations, the fuel calculation component 330 can also use motion data 317 in order to determine the estimation of fuel consumption for the actual route taken.

In one embodiment, the fuel calculation component 330 estimates the fuel efficiency for the hypothetical routes 391 based on stored or recorded information about the alternative routes 391. For example, a route mileage store 335 can store fuel efficiency information for various different routes. The fuel efficiency information can be determined by, for example, observing a population of drivers on which the vehicle monitor device 20 is provided. In one implementation, route mileage store 335 stores relevant vehicle information (e.g., OBD data 313, motion data) from other vehicles, or subset of vehicles known to travel on the same roadways as those that comprise the routes 345, 391 that are being compared. As an alternative or addition, the route mileage store 335 can record, for example, (i) fuel efficiency parameters for those roadways or routes that are deemed optimal as between a given start and endpoint, or (ii) fuel efficiency parameters for those roadways or routes that are popular or commonly driven. The fuel efficiency parameters can correspond to, for example, any one or more of (i) a numeric measure which can be correlated to fuel efficiency of consumption of a given roadway a route (e.g., a number that estimates efficiency by percentage as compared to a hypothetical optimal number); (ii) estimated OBD data 313 for a given roadway or route; and/or (iii) estimated volume of fuel consumption or mileage for a given roadway or route.

As an alternative or addition, the fuel calculation component 330 can obtain roadway parameters 393 from the map service 390 in determining fuel efficiency for routes 345, 391. Roadway parameters 393 can be determined for each of the routes 345, 391. The roadway parameters 393 can include, for example, traffic (or estimated vehicle speed), elevation variations, brake points and other considerations which can affect mileage. The roadway parameters 393 can, for example, be used to weight mileage determination for a vehicle on an actual route 345, as compared to a hypothetical route 391.

Still further, the fuel calculation component 330 can use information determined from the user profile store 315 in estimating fuel usage by the vehicle on the actual route 345 and/or hypothetical routes 391. For example, the vehicle type can be stored as profile information within the user profile store 315. In one implementation, the vehicle type can be used to weight, for example, fuel consumption estimation for certain roadways. For example, vehicle type can correspond to hybrid, in which case the fuel calculation component can weight slow moving roadways more efficient than fast moving roadways.

The fuel calculation component 330 can communicate a fuel metric 355 to the route analysis component 340 as a basis for comparing routes 345, 391. In one implementation, the route analysis component 340 compares fuel metrics 355 for individual routes between the start and end points 341 in order to determine which route uses the least fuel. By way of example, the fuel metric 355 can correspond to an estimation of an amount of fuel used by a vehicle on a given one of the routes (actual or hypothetical). In another implementation, the fuel metric 355 can correspond to a quantitative or qualitative measure of the fuel consumption of the vehicle, based on route selection. For example, the fuel metric 355 can be a relative measure (quantitative or qualitative) that indicates the best route for a given trip when fuel conservation is being optimized, without indicating the actual mileage or fuel consumption that would be expected. The route analysis component 340 can, for example, compare the fuel metric 355 of the actual route 345 with one or more hypothetical routes to determine if the user selected the most optimal route for purpose of fuel conservation.

The route analysis component 30 can include a device interface to communicate information to the user about route selection and optimization for fuel usage or other vehicle metric. In an example of FIG. 3, the route analysis component 340 communicates an output 341 to a mobile device interface 350. The mobile device interface 350 can, for example, link a network service on which the route analysis system 30 is provided to a particular device of the user on which a corresponding application is executed. The mobile device interface 350 can generate reports and/or notifications as whether a selected route of the user is optimal, or whether the user selected the most optimal route. In one implementation, the route analysis component 340 can generate a report while the user is on a trip (e.g., between the start and end points 343). For example, based on a start point and repeated past routes, the route analysis system 30 can guess that the user is on a trip between a starting point and an end point. When the user is on the trip, the mobile device interface 350 can communicate a report that identifies the most optimal route for the user to take. Thus, for example, the user can receive real-time information as for which routes the user should take in a vehicle in order to drive on an optimized route, during a time period when the user is on a trip (e.g., between the starting and finishing points).

Alternatively, the route analysis system 30 can provide input as to the user's route selection by analyzing the user's route as historical information. In such an implementation, a report 331 can be generated that identifies optimal routes (for fuel conservation) as between a given start and end point. The output 341 communicated through the mobile device interface 350 can thus be provided in context of a route that the user should have taken previously in order to improve fuel optimization.

Optimizing Driver Behavior and Actions

As an addition or alternative to determining optimal routes for fuel efficiency or consumption, fuel calculation component 330 can analyze vehicle information to detect driver behavior or actions which reduces fuel efficiency. In one implementation, OBD data 313 and/or motion data 317 is analyzed in order to determine driver behavior and/or actions which negatively affects the fuel consumption of the vehicle. By way of example, motion data 317 can be used to detect and measure braking and acceleration events. The fuel calculation component 330 can analyze braking and acceleration events to detect when the driver over-braked or accelerated too quickly, thereby negatively affecting the vehicle's fuel consumption.

The OBD data 313 can also be analyzed to detect and/or confirm other kinds of driving behavior or action, such as the driver maintaining vehicle in low gear or running engine at unnecessary high RPM. In one implementation, the fuel calculation component 330 can analyze the OBD data 313 and/or the motion data 317 in order to determine driving events and actions which can be modified or avoided to improve the vehicle's fuel consumption and/or efficiency. In order to determine such events, the OBD data 313 and/or motion data 317 can be compared to corresponding model data 327. The model data 327 can be made specific to the vehicle type and/or roadway. When motion data 317 and/or OBD data 313 varies from model data 327, the fuel calculation component 330 can identify the driving duration of the variation as an event.

The fuel calculation component 330 can map the event to a specific driving action or behavior using a library 329 that correlates vehicle information (e.g., OBD data 313 or motion data 317) to driver actions. The library 329 can further include content, such as text-based statements, which identify the unwanted driver behavior or action, and the corrective action the driver is recommended to take. The fuel calculation component 330 can generate data 339 corresponding to a recommendation output 349 pertaining to the identified driver behavior or action, and the recommendation output 349 can include the content identified from the library (e.g., content identifying the unwanted driver action and the corrective action). By way of example, the recommendation output 349 can identify the undesirable driver action (e.g., “You braked excessively when you came to a stop”), the location where the undesirable action occurred (e.g., “on Roadway AB”, “at the intersection of AB and C”, “at the stop sign on Roadway C” etc.), and the recommended correction (e.g., “give more time to stop”).

While an example of FIG. 3 is provided in context of a vehicle metric that corresponds to fuel consumption, alternative embodiments can optimize route selection for other kinds of vehicle metrics. For example, variations provide for optimizing route selection and/or driver performance for vehicle metrics which optimize longevity of select vehicle components. For example, a tire usage monitor can replace the fuel calculation component 330. The tire usage monitor can process data that corresponds to air pressure and speed (as OBD data 313), as well as braking determinations (which can be detected from an accelerometer).

Usage Profiling System

FIG. 4 illustrates a usage profiling system, according to an embodiment. A usage profiling system 40 can be implemented as part of the network service in connection with a vehicle monitor such as described with examples of FIG. 1, FIG. 2A or FIG. 2B. In particular, the usage profiling system 40 can be implemented to develop profile information regarding the manner in which a vehicle is used. Additionally, examples described herein implement functionality for the use of vehicle profile information in context of services that can be provided regarding the use of the vehicle.

With reference to an example of FIG. 4, the usage profiling system 40 includes a vehicle device interface 410, a usage profile 420, a vehicle profiler 430 and one or more service interfaces 440, 450. The vehicle device interface 410 communicates with the vehicle monitor device 20 of one or more vehicles, such as shown with examples of FIG. 1, FIG. 2A and FIG. 2B. The vehicle device interface 410 can communicate to receive vehicle information 401 from each vehicle monitor device 20. The vehicle information 401 from each vehicle monitor device 20 can include an identifier 405, as well as GPS data 412, OBD data 413 and/or motion data 417.

The vehicle device interface 410 can utilize an account store 415 to link the identifier 405 to an account 407 in which the corresponding vehicle monitor device 20 is mounted. In one embodiment, the account 407 that is associated with a particular identifier 405 also identifies a set of driver identifiers 409 for the corresponding vehicle. Each driver identifier 409 in turn can correspond to an individual in a household associated with the particular account 407.

As an example, the vehicle device interface 410 can receive communications from multiple vehicle monitor devices 20 mounted on different vehicles. The communications from each of the vehicle monitor devices 20 can include a respective identifier 405, which in turn is linked to a corresponding account 407 in the account store 415. Furthermore, each account 407 can identify a number of known drivers 409 for the particular vehicle. For example, a household can be registered for a particular vehicle, and the household can further identify multiple drivers for the vehicle.

In an example of FIG. 4, vehicle device interface 410 communicates the vehicle information 401 to multiple other components, including usage profiler 420 and/or vehicle profiler 430. The usage profile 420 utilizes at least some of the vehicle information 401 in order to determine and utilize a driver profile for the vehicle. Likewise, the vehicle profiler 430 uses at least some of the vehicle information 401 to determine and utilize profile information in connection with the vehicle and its components.

In an embodiment, the vehicle information 401 received by the usage profiler 420 includes motion data 417, OBD data 413, and GPS data 412. The usage profiler 420 can utilize the vehicle information 401 to determine a usage profile 425 for a given instance during which a vehicle is in use. For example, the usage profiler 420 can develop a usage profile 425 for a given trip that is in progress. Alternatively, the usage profiler 420 can develop usage profiles 425 for previously completed trips.

In one embodiment, the usage profiler 420 operates to “fingerprint” the driver in a particular trip based on determined usage profiles 425 for individual trips of the vehicle. The fingerprint of the driver can be based on comparing the usage profile 425 of the driver to a known user model 427 for that driver. In one implementation, the usage profiler 420 determines when a usage profile 425 is a first-impression of a particular driver, then determines a particular user model 427 for the driver based on the usage profile 425. The user model 427 can be stored as part of a usage model store 435 for the particular account. Additionally, each user model 427 can be associated with a driver ID 409. When a given usage profile 425 is determined for a particular trip, the usage profile 425 is compared against a set of models that are maintained in the user model store 435 for the particular account.

Subsequent characteristics exhibited by the driver can be stored as part of the user model. For example, the driver may learn to drive slower, or brake less suddenly, and the changed characteristics of the driver can be reflected in the user model 427.

In determining usage profiles 425 for comparison and/or implementation as models 427, the user profiler 420 can utilize one or more of GPS data 412, OBD data 413, or motion data 417. Among other information, the usage profile 425 can identify motion characteristics, such as braking characteristics. By way of example, the motion characteristics can include characteristics (e.g., magnitude and/or duration) of braking, magnitude of braking at different speeds, braking pattern, acceleration pattern, and/or average speed on specific roadways or different types or roadways (e.g., roadways with different speed limits). The usage profile 425 can also include OBD characteristics, which can incorporate parameters such as RPM, speed (from speedometer), fuel usage parameters (e.g., manifold air pressure) etc. Furthermore, the usage profile 425 can also associate routes or roadways with specific usage models. Accordingly, the GPS data 412 can also be used to determine the usage profile 425 of the given trip, and the determined routes can form part of a given user model 427 associated with one or more of the drivers.

As an alternative or variation, the usage models 435 can reflect a driver type (aggressive or careful etc.), driver demographic (e.g., young, over 40, male/female etc.) rather than a specific driver. In one implementation, the usage profiler 420 determines the usage profile 425, then categorizes the usage profile 425 based on pre-defined categories and corresponding category models (which can be stored in the usage data store 435). As such, the variation provides for usage models 435 to identify specific usage characteristics of how a vehicle is being driven or operated for a class of drivers (e.g., adult males, adult females, senior citizens, teenagers) rather than a specific individual.

The usage store 435 can be maintained to track use of a given vehicle for each user model (i.e., driver) associated with that vehicle. When the usage profile 425 is deemed to match one of the models 427, then trip information 431 for the particular trip is stored in a usage store 439. The trip information 431 can be correlated to the driver ID 409 for the particular user model 427 that was deemed to match the usage profile 425. The trip information 431 can correspond to, for example, mileage or distance traveled and/or time duration of travel. In variations, other metrics can also be determined, such as high speed of trip, average speed of trip, or time of day when trip occurred.

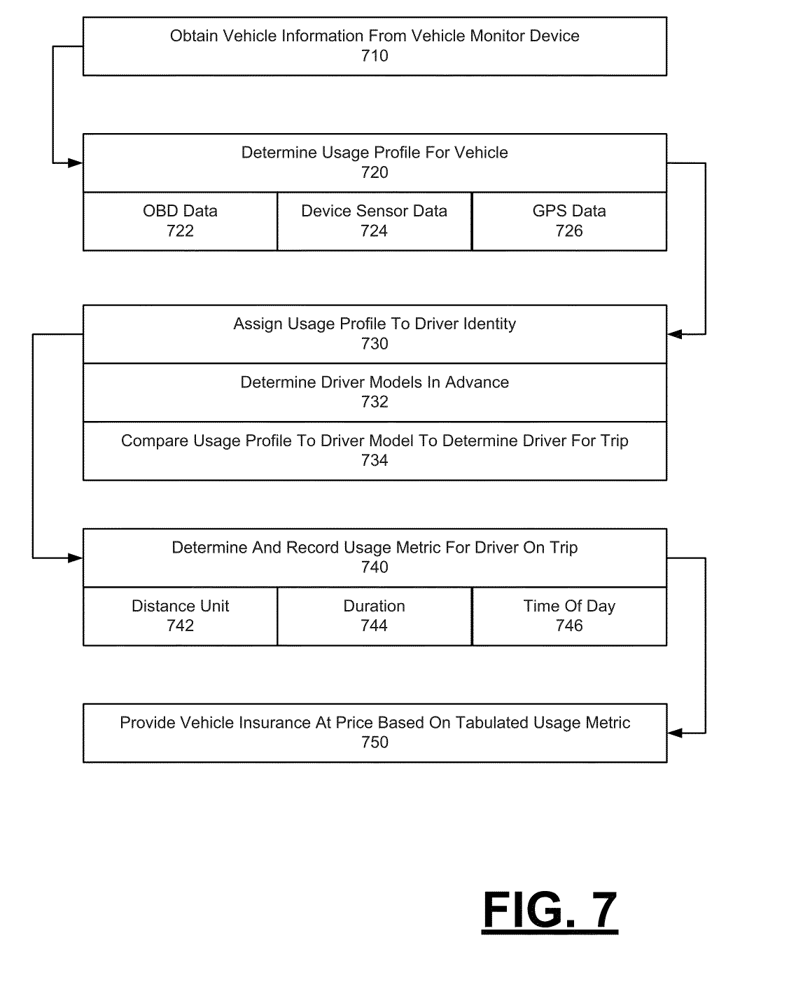

In an embodiment, a service interface 440 accesses the usage store 439 in order to obtain usage data 437. The usage data 437 can also be correlated to the driver identifier 409, in order to identify (i) a particular driver (or category of driver) for an account (which can, for example, represent a household), and (ii) an amount that the monitored vehicle is driven by the identified driver. The identification (or fingerprinting) of the driver can be done programmatically and without input from the driver. The service 40 can use the information for a variety of purposes. For example, as described with an example of an FIG. 7, the service 40 can use the usage data 437 in order to provide a per-mile liability insurance for the monitored vehicle. By way of example, in other implementations, the service 40 can use the usage data 437 in order to set a fee for using the vehicle, or for determining other types of insurance or warranties services such as maintenance repair.

The vehicle profiler 430 receives vehicle information 401 from the vehicle device interface 410. In an example of FIG. 4, the vehicle profiler 430 utilizes OBD data 413 and GPS data 412. Among other operations, the vehicle profiler 430 can obtain as part of the OBD data 413, sensor readings regarding various facets of the operation of the vehicle. By way of example, the OBD data 413 obtained by the vehicle profiler 430 can include sensor readings for the engine, oil level reading, and tire pressure readings. The vehicle profiler 430 can process the OBD data 413 in order to generate a vehicle profile 465 for a given time period. The vehicle profile 465 can include calculations as to when the driver of the vehicle has to replace, for example, certain vehicle fluids such as engine oil or braking fluid.

The vehicle profile 465 can further identify (i) amount of usage for a given component (e.g., brakes), (ii) fluctuation in sensor level indicating component of vehicle is degrading, (iii) sensor level in vehicle indicating component of vehicle will soon need replacement. In this way, the vehicle profiler 430 can determine longevity (or life remaining before failure) for multiple components of the vehicle.

Additionally, the vehicle profiler 430 can utilize position information to further estimate longevity of one or more components. For example, the vehicle profiler 430 can estimate the life of a component of the vehicle based on a set of sensory values, then update longevity based on the mileage of the vehicle subsequent to the longevity estimation.

The vehicle profiler 430 can receive vehicle information 401 for multiple vehicles, and further store multiple vehicle profiles 465 for each vehicle. A vehicle profile store 455 can retain the various vehicle profiles 465. One or more service interfaces 450 can interface with the vehicle profile store 455 in order to obtain vehicle profiles 465 for one or more vehicles. By way of example, a maintenance/repair warranty or insurance service can obtain one or multiple vehicle profiles 465 for a given vehicle in order to calculate longevity of the vehicle and its components, and further to estimate the cost of insurance premiums for the service given the estimated longevity of the vehicle and the components.

Methodology

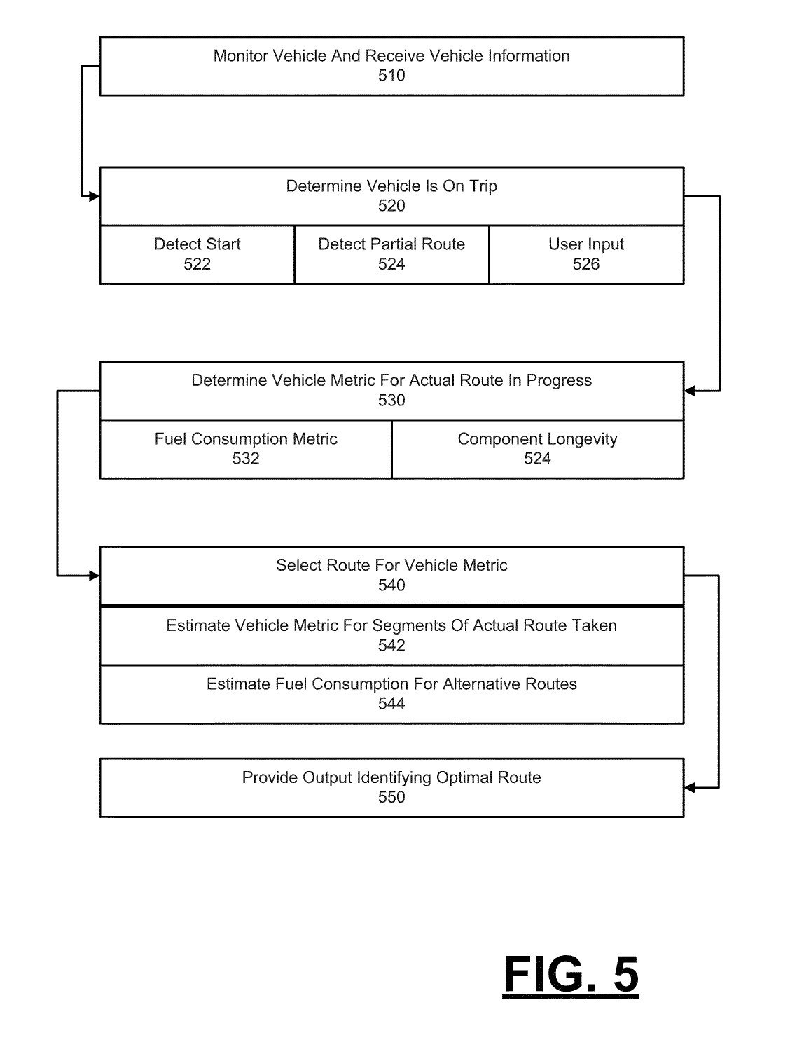

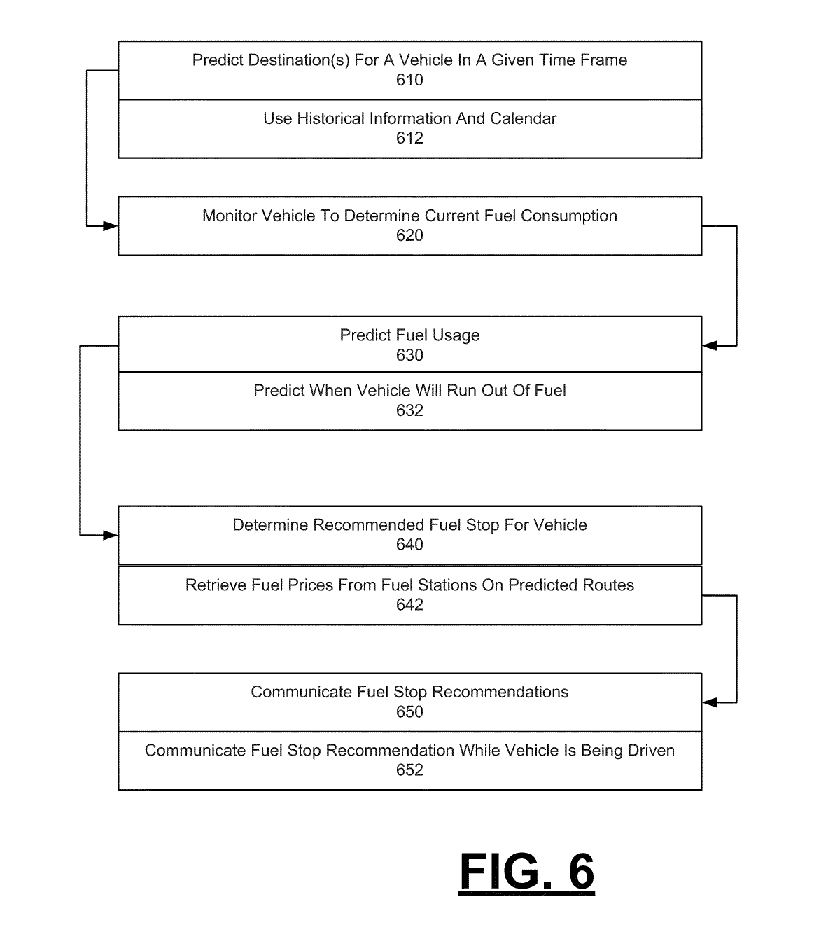

FIG. 5 illustrates an example method for optimizing a route of a vehicle based on a vehicle metric such as fuel consumption, according to an embodiment. FIG. 6 illustrates an example method for estimating fuel stops for a monitored vehicle, according to an embodiment. In describing examples of FIG. 5 or FIG. 6, reference can be made to other embodiments, including an example of FIG. 3, in order to describe a suitable component for performing a step or sub-step being described.

With reference to FIG. 5, a network service can monitor a vehicle by receiving vehicle information 301 from the vehicle monitor device 20 of the monitored device (510). The vehicle information 301 can include OBD data 313, GPS data 312, and/or motion data 317.

Based on the vehicle information 301, the network service can make a determination as to when the vehicle is on a trip (520). One implementation provides that the trip is detected upon the vehicle departing from a start point (522). In a variation, the trip is detected upon sufficient information to determine a partial route, before the route is complete (524). For example, the trip can be determined once a vehicle enters a roadway that is determined to lead to a business district or to a highway. Still further, in another variation, the trip can be determined as taking place when there is user-input indicating as such (526). For example, the driver can log each occurrence of their driving a particular vehicle.

The network service can determine a vehicle metric for the actual route in progress or taken (530). The actual route can correspond to a route that is determined to be in progress as between the start and end points. Alternatively, the actual route can be one that the vehicle previously undertook.

In one embodiment, the vehicle metric corresponds to or is based on fuel consumption (532). As described with FIG. 3, for example, the fuel calculation component 330 can estimate fuel efficiency of the vehicle when it is being driven. The fuel efficiency can be determined from OBD data such as (i) receiving fuel consumption information in real-time from the vehicle, (ii) estimating fuel information from sensor readings such as mass airflow, manifold air flow pressure, RPMs, intake air temperature, speed, tire pressure, brake usage data, and oil pressure. Still further, the fuel efficiency can be determined in part from motion data 317, which can be obtained from, for example, an accelerometer (or combination of accelerometers) within the vehicle (e.g., within vehicle monitor device 20). As still another addition or variation, the fuel efficiency can be determined in part from GPS data 312. For example, fuel efficiency can be rated based on roadways that comprise the route or portion of the estimated route that the vehicle is traveling on. Still further, the fuel efficiency can be estimated from a combination of data, such as from motion data 317 (which can provide speed, acceleration, stopping etc.) and GPS data 312 (which can provide distance driven).

In variations, the vehicle metric corresponds to component longevity (534). By way of example, the vehicle metric can correspond to estimated longevity of one or more of the brakes or tires. In one implementation, a calculation component can use metrics from OBD data 313 to estimate remaining life of a component (e.g., brakes). Additional logic can use other sources of data (e.g., motion data 317, GPS data 312) to estimate depletion of the component for the actual route taken.

The network service can select a route between the determined start and end points that is optimized for the vehicle metric (540). The selected route can, for example, modify a route that was actually taken by substituting an alternative roadway or combination of roadways for ones that are actually part of the route.

In optimizing the route, the vehicle metric is estimated for segments or portions (e.g., roadways) of the actual route taken (542). In an embodiment, the vehicle metric corresponds to fuel consumption, and the determination of fuel consumption can be determined at least in part from the OBD data 313. In one implementation, the OBD data 313 includes fuel tank readings, which can be tabulated. In a variation, the fuel consumption is estimated from OBD data, using an Ideal Gas Law formula, which determines fuel consumption from mass air-flow (MAF). A formula under the Ideal Gas Law provides:

IMAP=RPM*MAP/IAT/2 (Equation 1)

In Equation 1, RPM is engine speed in revolutions per minute, MAP (manifold absolute pressure) is measured in KPa, and IAT (intake air temperature) is measured in degrees Kelvin. This integrated value can be converted into total air flow (grams) using the following equation:

(grams of air)=(IMAP/60)*(Vol Eff/100)*(Eng Disp)*(MM Air)/(R) (Equation 2)

In Equation 2, R is 8.314 J/° K/mole and the average molecular mass of air is 28.97 g/mole. The MAF when integrated over time can be used calculate fuel flow using a specific air/fuel mixing ratio (A/F), which can range from 6 to 22. In one implementation, the total mass of air which flows through the engine (as measured by the MAF sensor or calculated using MAP, RPM and IAT) can be divided by the A/F ratio (e.g., 14.7) to derive the total mass of fuel that has been burned. If the air mass is measured in grams, then the calculated amount of fuel will also be in grams. For example, using an average density of gasoline of 6.17 pounds per gallon and knowing that there are 454 grams per pound, then dividing the total fuel mass in grams by (454*6.17) yields the total number of gallons of fuel burned for a given amount of air (as measured by the MAF sensor). Fuel consumed can be estimated from integrated MAF using the following formula:

(gallons of fuel)=(grams of air)/(air/fuel ratio)/6.17/454

Knowing the total fuel consumed and the distance traveled, the fuel consumption rate in MPG (miles per gallon) then can be calculated.

Fuel consumption (or other vehicle metric) can also be estimated for alternative routes, including alternative roadways that the vehicle can take between the start and end points (544). The determination of the vehicle metric for the alternative roadways can be based on, for example, (i) data obtained from other vehicles (e.g., other vehicles on which the vehicle monitor device 20 is provided), (ii) data obtained from the vehicle being monitored (e.g., historical data of fuel consumption when vehicle has traveled on other roads), and/or (iii) estimations made from a mapping service.

Still further, some embodiments recognize that enhancements can be made in certain situations or applications as to the implementation and/or use of the Ideal Gas Law (see Equation 1). Specifically, embodiments recognize that vehicle data 255 (see e.g., FIG. 2A) can incorporate data from multiple kinds of sensors, and further that sensor readings for different kinds of vehicles can be inaccurate. For example, the MAF-based calculations for some vehicles is recognized by some embodiments as being relatively inaccurate as compared to other vehicles. In one implementation, current fuel level information is determined from the OBD data as a ground truth signal. Other OBD data elements, such as commanded EGR (Exhaust Gas Circulation), EGR Error, ambient temperature and humidity in nature, catalyst temperature, oil temperature, vehicle age, and vehicle mileage, can be correlated with the ground truth signal. Examples further can implement a true gas usage formula that is assumed to be a log-linear function of the Ideal Gas Law's formula output. Their coefficients of the log linear function can be fitted using a methodology such as least-squares in combination with the fuel level sensor output.

In one implementation, the data obtained from other vehicles can identify an amount of fuel that was estimated as being consumed. The amount of fuel consumed by other vehicles can also be estimated from OBD data obtained from other vehicles traveling on other roads. In variations, alternative roadways can be scored or graded in terms of fuel consumption based on (i) OBD data obtained from other vehicles, (ii) actual fuel consumption data obtained from other vehicles, (iii) information about the roadways that would affect fuel consumption (e.g., average speed, number of stop signs or lights, distance of road, slope of road etc.).

In determining optimal routes, some embodiments factor in real-time road conditions. For example, in one implementation, the optimal route for determining fuel efficiency can be weighted by parameters that measure traffic and/or weather conditions.

The route analysis system 30 can provide an output identifying an optimal route for fuel consumption (or other vehicle metric) (550). In an example such as shown by FIG. 1, the route analysis system 30 detects when the vehicle 10 is on a trip, and then communicates with the mobile device 70 to suggest an optimal roadway or route segment for the user to complete the trip. In a variation, the route analysis system 30 analyzes prior or historical routes taken by the vehicle, and then suggests alternative routes that the vehicle should have taken in order to conserve fuel.

Thus, by way of example, a method such as described by FIG. 5 can be implemented using a route analysis system 30 in order to detect when the vehicle is on a trip. In such an implementation, an output of an example such as provided by FIG. 5 can include a recommendation to the user (e.g., via the mobile device 70 (see FIG. 1)) for a particular roadway to the endpoint based on estimated fuel consumption. The determination of the roadways with the optimal fuel consumption can further account for traffic conditions on other routes.

With reference to FIG. 6, the destinations for a monitored vehicle are predicted for a given duration of time (e.g., one day, three days, a week) (610). In an embodiment, historical information regarding the driver's points of destinations can be recorded and referenced in order to make the predictions. Furthermore, the historical information can be referenced against a calendar in order to provide a predictive mechanism of what the points of destination will be for a driver in a given time frame (612). As such, a driver's destinations can be recorded over a given duration of time, so that a driver's typical destinations for a given day of the week can be predicted with a suitable level of confidence. In implementation, the route analysis system 30 can record GPS data 312 for a monitored vehicle in order to determine trips and points of destinations for a vehicle over a given duration of time (e.g., week). By way of example, the trip pattern for a given driver may indicate that the driver takes trips to a particular point of destination (work) on weekdays.

The route analysis system 30 can monitor the vehicle in order to determine the vehicle's current fuel consumption (620). For example, as described with FIG. 3 and FIG. 5, the fuel calculation component 330 can calculate fuel usage based on OBD data 313, GPS data 312, and/or motion data.

The route analysis system 30 can further use the historical information on the points of destination and the calendar in order to predict the user's fuel usage at a given instance (630). The fuel usage prediction can look forward hours or days from a present moment in time. For example, the network service can determine the fuel usage of the vehicle on a Monday for the remainder of the week, based on historical information that indicates the user drives the vehicle to work each day of the week.

With the fuel usage determined, the route analysis system 30 can also estimate the time and/or location when the vehicle will run out of fuel (632). For example, the route analysis system 30 can estimate that the vehicle will need refueling no later than a given day and time (e.g., before the driver heads to work on Thursday).

Based on the estimation as to when the vehicle will run out of fuel, the route analysis system 30 can determine a recommended fuel stop for the vehicle (640). The recommended fuel stop can identify (i) when the user should stop for fuel, and (ii) the specific fuel stations that the user should stop at for fuel. The determinations as to which gas station the vehicle should stop at can be based on fuel cost, location, and crime levels in the surrounding area. For example, route analysis system 30 can retrieve fuel prices for fuel stations on the driver's predicted routes (642). The determination of (640) can be made when the fuel level of the vehicle meets some threshold (e.g., quarter of a tank, two days remaining). The identification of fuel stations can thus be based on routes that the driver is anticipated to take. For example, roadways in the predicted routes of the user can be identified. The route analysis system 30 can then query the mapping service in order to determine the location of the fuel stations on the roadways of the predicted routes, as well as the fuel price for each of the identified fuel stations.

In one embodiment, the determination of which fuel stations the driver should stop at can be based on optimizing fuel cost. For example, if the vehicle being monitored is near-empty on fuel, the route analysis system 30 can perform calculations to determine that the user can drive to his or her next predicted destination, and further that a particular fuel station near the next predicted destination has the cheapest fuel of those fuel stations that are near the predicted routes. As another example, the route analysis system 30 may determine that while the user may have sufficient fuel to drive to the next destination, a nearby fuel station offers the lowest fuel price as compared to other stations on the predicted routes. The route analysis system 30 then determines that the user should stop and fuel before being completely empty in order to obtain the cheapest gas price.

The route analysis system 30 can communicate fuel stop recommendations to the user. Further, in one embodiment, the fuel stop recommendations can be communicated when the vehicle is being driven (652). With reference to an example of FIG. 1, for example, the route analysis system 30 can message or otherwise display a notification to the mobile device 70 of the driver. The notification can identify the suggested fuel stop, provide directions to the fuel stop, and further provide an indication as to the amount that the driver can save from that particular fuel stop.

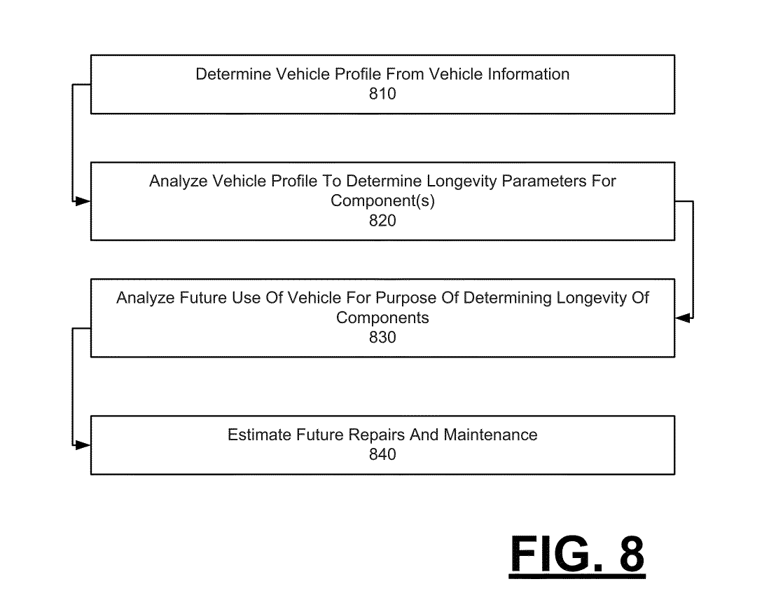

FIG. 7 illustrates an example method for fingerprinting a driver utilizing a monitored vehicle for purpose of providing services that account for individual drivers, according to an embodiment. FIG. 8 illustrates a method for estimating future repair or service events based on vehicle information of a monitored vehicle, according to an embodiment. In describing examples of FIG. 7 and FIG. 8, reference may be made to examples provided with other figures, including with an example of FIG. 4, for purpose of illustrating suitable components or elements for performing a step or sub-step being described.

With reference to FIG. 7, the usage profiling system 40 can obtain vehicle information 401 from a vehicle monitor device 20 provided in a given vehicle (710). As described with an example of FIG. 4, the vehicle information 401 can include OBD data 413, motion data 417 and/or GPS data 412.

Each instance the vehicle is used, a usage profile can be determined for the vehicle (720). The usage profile 425 can be determined from the vehicle information 401, using parameters that are distinctive to the driving style of a given driver. In one implementation, the usage profile can be determined from OBD data (722). In a variation, the usage profile can be determined from device sensor data (e.g., accelerometer) (724). Still further, the usage profile can be determined GPS data, such as position information that indicates the route of the driver (726). Still further, other input can be used to determine the usage profile of the driver, including user input indicating the driver identity. Among other characteristics, the vehicle information 401 can be used to obtain, for example, (i) braking frequency, (ii) stopping distance, (iii) braking magnitude, (iv) acceleration profiles, (v) RPMs typically used, and (vi) speed or speed under particular conditions or roadways. Examples further recognize that many parameters available through OBD data can inherently be distinctive of a particular driver or driver type (aggressive, careful, etc.).

The usage profile determined on each use of the vehicle can be recorded and assigned to a particular driver identity (730). The driver identity can correspond to a particular driver or a class or category of driver. In an implementation when the usage profile is assigned to a specific driver, a user model 427 of the different drivers may be developed in advance (732). The user model 427 can, for example, be in the form of a vector or matrix that quantifies driver-specific characteristics as determined from the OBD data 413, the motion data 417 and/or the GPS data 412. Multiple user models 427 (e.g., representing the drivers of a household) can be assigned to a single vehicle monitor device 20 (or account). Each of the multiple possible user models 427 can provide a basis for comparison against usage profiles 425. In this way, each usage profile 425 can be correlated to a fingerprint of a driver of the vehicle. The determined usage profile 725 for a particular trip can be compared to the different models associated with the vehicle monitor 720 in order to determine which of the drivers associated with the device are driving the vehicle (734).

Additionally, a usage metric is determined and recorded for the driver for the trip (740). The usage metric can be identified through the usage profile. The recorded usage metric can include distance driven (742). Alternatively, the usage metric can include a duration of the trip (744). Still further, other metrics such as time when vehicle is driven (e.g., after midnight) can be recorded (746).

According to some embodiments, vehicle insurance (e.g., liability insurance, collision insurance etc.) can be provided for a vehicle at a price that is determined from tabulating the usage metric for each driver (750). In one implementation, the monitored vehicle can be insured based on an insurance rate assigned to each driver of the household. The insurance rate assigned to each driver can be provided per-unit distance (e.g., per mile) or per duration that vehicle is driver (e.g., per hour). In this way, each instance when the vehicle is used can be correlated to an insurance rate that is dependent on (i) an amount that the vehicle is used, and (ii) the driver of the vehicle.

With reference to an example of FIG. 8, a vehicle profile is determined from vehicle information communicated by the vehicle monitor device (810). The vehicle information can include OBD data 413, motion data 417 and/or GPS data 412. The vehicle profile can be obtained over multiple trips of the vehicle.

The vehicle profile can be analyzed in order to determine longevity parameters for one or more components of the vehicle (820). For example, longevity parameters can be determined for engine or engine components, brakes and/or tires. In determining longevity, the OBD data 413 can be analyzed for sensor readings that indicate, for example, problems or potential degradation of components.

The future use of the vehicle can be analyzed for purpose of determining longevity of particular components (830). According to some embodiments, the vehicle profile can be compared against a usage profile for the vehicle that indicates, for example, the amount that the vehicle is expected to be driven, and pertinent characteristics as to how the vehicle is to be driven. For example, the vehicle profiler 430 can analyze the vehicle information 401 (e.g., OBD data 413 relevant to brakes) in order to determine when sensors pertaining to braking of the vehicle indicate the brakes are degraded. To estimate longevity, one embodiment provides for predicting the length of time that the vehicle will be driven, as well as the expected manner in which the particular component (e.g., brakes) will be used. The prediction as to the manner in which the vehicle will be driven can be based on historical data. For example, the percentage of miles a vehicle is driven by each driver in a prior duration (past month or six months), and the manner in which each driver drives the vehicle (e.g., amount of braking) can be used to estimate the longevity of the particular component.

An estimation of future repairs or maintenance can be determined based on the future determinations of the vehicle use (840). In one embodiment, a maintenance insurance can be priced on the estimated longevity remaining for individual components of the vehicle.

In a variation, the estimation of longevity of components can also account for fingerprinting a driver when the vehicle is being driven. For example, the determination of which driver is driving the vehicle can be used to estimate or calculate a parameter that affects longevity of a particular component. For example, in one implementation, a driver profile is determined based at least in part on on-board diagnostic data. The driver profile can be determined from one of multiple possible driver profiles for a given vehicle. An amount can be determined (e.g., distance driven or duration of time), reflecting a quantity that vehicle is anticipated to be used in the future by each of the multiple possible drivers. The determination can be based at least in part on the driver profile of the vehicle at each of the multiple instances. Additionally, one or more future repair or maintenance requirements can be determined based at least in part on the determined amount.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for analyzing route information for a vehicle, the method being implemented by one or more processors and comprising:
(a) determining when a vehicle is on a trip, including a starting point or a destination;
(b) obtaining on-board diagnostic data from the vehicle during the trip;
(c) determining a vehicle metric for the vehicle based at least in part on the on-board diagnostic data; and
(d) determining a route between the starting point and the destination that is optimized for the vehicle metric.

2. The method of claim 1, wherein determining the vehicle metric includes determining a fuel efficiency of the vehicle based at least in part on on-board diagnostic data that includes one or more of mass airflow, manifold air pressure, revolutions-per-minute, and intake air temperature.

3. The method of claim 1, wherein determining the route includes comparing a route taken by the vehicle between the starting point and the destination with one or more alternative routes in order to determine the route that is optimal based on the vehicle metric.

4. The method of claim 1, wherein the vehicle metric corresponds to a longevity parameter for one or more components of the vehicle.

5. The method of claim 1, further comprising determining that the trip is in progress from a server, then automatically performing (a) through (d).

6. The method of claim 1, wherein (d) includes determining that the trip is complete, and sending a report to a device associated with the user that shows the optimal route.

7. The method of claim 1, wherein (d) includes suggesting a route and/or time of travel before when the vehicle is to travel to the destination again.

8. A method for analyzing route information, the method being implemented by one or more processors and comprising:
(a) predicting one or more destinations for a vehicle in a given time frame;
(b) obtaining on-board diagnostic data from the vehicle;
(c) determining, based at least in part on the on-board diagnostic data, suggested route information for the vehicle; and
(d) communicating suggested route information to a device or account associated with the vehicle.

9. The method of claim 8, wherein the method further comprises determining a fuel consumption of the vehicle based at least in part on the predicted one or more destinations, and wherein (c) includes determining one or more suggested fuel stops for the vehicle based at least in part on the determined fuel consumption.

10. The method of claim 9, wherein the method further comprises determining pricing information for multiple fuel stops that are accessible from routes to the predicted one or more destinations, and wherein determining one or more suggested fuel stops for the vehicle is also based on the pricing information for the multiple fuel stops.

11. The method of claim 8, wherein (a) includes using historical routes and/or destinations in conjunction with a calendar to predict one or more destinations for the vehicle.

12. The method of claim 8, wherein (c) includes determining an optimal route for a given destination. D

13. The method of claim 12, wherein (b) includes determining a fuel efficiency of the vehicle based at least in part on on-board diagnostic data that includes one or more of mass airflow, manifold air pressure, revolutions-per-minute, and intake air temperature.

14. A system comprising:
a vehicle monitor device to interface with a vehicle and obtain on-board diagnostic information from the vehicle, the vehicle interface including a wireless transmitter to communicate the on-board diagnostic information to a computing destination;
one or more processors associated with the computing destination that use the on-board diagnostic information to calculate at least one of a vehicle metric or route information for the vehicle.

15. The system of claim 14, wherein the vehicle metric includes fuel efficiency, and wherein the route information is at least partially determined from the fuel efficiency of the vehicle.

16. The system of claim 14, wherein the one or more processors associated with the computing destination include a server that communicates with the vehicle monitor to receive the on-board diagnostic information, and a mobile device within the vehicle that receives data that is based on the on-board diagnostic information.

17. The system of claim 16, wherein at least one of the server or the mobile device perform calculations that utilize the on-board diagnostic data in order to determine a suggested route that is optimized for at least the vehicle metric.

18. The system of claim 17, wherein the vehicle metric corresponds to fuel efficiency.

19. The system of claim 16, wherein the server obtains pricing information for fuel stations that are accessible to one or more routes that the vehicle is predicted to take, and wherein the route information identifies a suggested fuel station for the vehicle.

20. The system of claim 15, wherein the vehicle monitor includes one or more components that determine a metric of position of movement independently of the on-board diagnostic information.
